(19) United States
(12) Patent Application Publication
(10) Pub. No.: US 2026/0205429 A1
(43) Pub. Date: Jul. 16, 2026

(54) METHOD AND DEVICE WITH CONVERSATIONAL COMPREHENSION DETERMINATION

(71) Applicants: SAMSUNG ELECTRONICS CO., LTD., Suwon-si (KR); Korea Advanced Institute of Science and Technology, Daejeon (KR)

(72) Inventors: Jiho KIM, Daejeon (KR); Yoonjae CHOI, Daejeon (KR); Woosog CHAY, Daejeon (KR); Hyeonji HWANG, Daejeon (KR); Daeun KYUNG, Daejeon (KR); Hyunseung CHUNG, Daejeon (KR); Eunbyeol CHO, Daejeon (KR); Yohan JO, Seoul (KR); Hodong LEE, Suwon-si (KR)

(73) Assignees: SAMSUNG ELECTRONICS CO., LTD., Suwon-si (KR); Korea Advanced Institute of Science and Technology, Daejeon (KR)

(21) Appl. No.: 19/385,709

(22) Filed: Nov. 11, 2025

(30) Foreign Application Priority Data
Jan. 13, 2025 (KR) 10-2025-0004738

(51) Int. Cl. H04L 51/02; H04L 51/04

(52) U.S. Cl. CPC H04L 51/02; H04L 51/04

(57) ABSTRACT

A processor-implemented method including transmitting, to a conversational agent, conversation data between a plurality of speakers and a predetermined query related to the conversation data, receiving a response to the query from the conversational agent, comparing the response with a predetermined answer corresponding to the query, and determining a conversational comprehension of the conversational agent based on a comparison result resulting from the comparing, the conversational agent being configured to generate the response to the query based on the conversation data upon receiving the query.

### CROSS-REFERENCE TO RELATED APPLICATIONS

This application claims the benefit under 35 USC §119(a) of Korean Patent Application No. 10-2025-0004738, filed on Jan. 13, 2025, in the Korean Intellectual Property Office, the entire disclosure of which is incorporated herein by reference for all purposes.

### BACKGROUND

### 1. Field

The following description relates to a method and device with conversational comprehension determination.

### 2. Description of Related Art

A conversational agent may refer to a system or software implemented to interact with a user based on a predetermined response rule via a messenger. A conversational agent may use pattern recognition technology that allows machines to identify voices/texts based on artificial intelligence (AI) and big data analysis technology for smooth conversations, natural language processing technology that allows computers to recognize human language to utilize it for question-answering and translation, semantic web technology that allows computers to understand and logically infer information, text mining technology that finds useful information from data consisting of texts, and situational awareness computing technology that understands the situation and context of a conversation partner. A conversational agent may be installed in various systems in many different fields. For example, conversational agents may be provided in the form of chatbots or service agents. Methods of evaluating the performance of conversational agents are being studied to evaluate and optimize the conversational comprehension and response speed of conversational agents.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including transmitting, to a conversational agent, conversation data between a plurality of speakers and a predetermined query related to the conversation data, receiving a response to the query from the conversational agent, comparing the response with a predetermined answer corresponding to the query, and determining a conversational comprehension of the conversational agent based on a comparison result resulting from the comparing, the conversational agent being configured to generate the response to the query based on the conversation data upon receiving the query.

The comparing of the response with the predetermined answer may include determining a similarity value between the response and the predetermined answer, in response to the similarity value being greater than or equal to a preset value, determining the comparison result to be a first value, and, in response to the similarity value being less than the preset value, determining the comparison result to be a second value.

The determining of the conversational comprehension may include determining the conversational comprehension based on comparison results from repeatedly performing the transmitting of the query, the receiving of the response, and the comparing of the response with the predetermined answer.

The determining of the conversational comprehension may include determining the conversational comprehension based on a ratio of the first value to the second value.

The determining of the conversational comprehension may include determining the comparison result to be the second value responsive to the response not being received within a predetermined time limit.

The transmitting of the conversation data may include transmitting the conversation data to the conversational agent sequentially according to a flow of a conversation and the conversational agent may be configured to generate the response to the query based on conversation data received up to a timepoint of receiving the query.

The conversation data stored in the conversational agent may be updated based on conversations conducted between the conversational agent and the plurality of speakers, and the conversational agent may be configured to conduct a follow-up conversation by utilizing updated conversation data.

The method may include skipping the updating of the conversation data responsive to a current update to the conversation data not being performed within a predetermined time limit,.

The conversation data may include a preset number of tokens, and the conversational agent may be configured to determine a conversation context based on the tokens to generate the response.

The transmitting of the query may include transmitting one of a set of predetermined queries at a random timepoint while a conversation is in progress.

The comparing of the response with the predetermined answer may include comparing the response with predetermined answers determined differently for each of the plurality of speakers.

In a general aspect, here is provided an electronic device including one or more processors including processing circuitry and a memory including one or more storage media storing instructions that, when executed individually or collectively by the one or more processors, cause the electronic device to transmit, to a conversational agent, conversation data between a plurality of speakers and a predetermined query related to the conversation data, receive a response to the query from the conversational agent, compare the response with a predetermined answer corresponding to the query, and determine a conversational comprehension of the conversational agent based on a comparison result resulting from the comparing, the conversational agent being configured to generate the response to the query based on the conversation data upon receiving the query.

The instructions, when executed by the one or more processors, may cause the electronic device to determine a similarity value between the response and the predetermined answer, in response to the similarity value being greater than or equal to a preset value, determine the comparison result to be a first value, and, in response to the similarity value being less than the preset value, determine the comparison result to be a second value.

The instructions, when executed by the one or more processors, may cause the electronic device to determine the conversational comprehension based on comparison results that are from iteratively performing the transmitting of the query, the receiving of the response, and the comparing of the response with the predetermined answer.

The instructions, when executed by the one or more processors, may cause the electronic device to determine the conversational comprehension based on a ratio of the first value to the second value.

The instructions, when executed by the one or more processors, may cause the electronic device to determine the comparison result to be the second value responsive to the response not being received within a predetermined time limit.

The instructions, when executed by the one or more processors, may cause the electronic device to transmit the conversation data to the conversational agent sequentially according to a flow of a conversation, and the conversational agent may be configured to generate the response to the query based on conversation data received up to a timepoint of receiving the query.

The conversation data stored in the conversational agent may be updated based on conversations conducted between the conversational agent and the plurality of speakers, and
the conversational agent may be configured to conduct a follow-up conversation by utilizing updated conversation data.

The instructions, when executed by the one or more processors, may cause the electronic device to skip the updating of the conversation data responsive to a current update to the conversation data not being performed within a predetermined time limit.

In a general aspect, here is provided a non-transitory computer-readable storage medium storing instructions that, when executed by a processor, cause the processor to perform the method.

Other features and aspects will be apparent from the following detailed description, the drawings, and the claims.

### BRIEF DESCRIPTION OF THE DRAWINGS

FIG. 1 illustrates an example electronic device according to one or more embodiments.

FIG. 2 illustrates an example method with conversational comprehension according to one or more embodiments.

FIGS. 3 and 4 illustrate example processes according to one or more embodiments.

FIG. 5 illustrates an example conversational agent according to one or more embodiments.

FIG. 6 illustrates an example process of determining conversational comprehension according to one or more embodiments.

FIG. 7 illustrates an example method according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

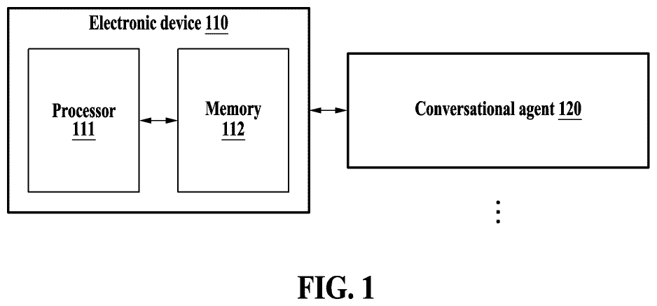

FIG. 1 illustrates an example electronic device according to one or more embodiments.

Referring to FIG. 1, in a non-limiting example, an electronic device 110 may include a processor 111 and a memory 112. The processor 111 may include at least one processor. The memory 112 may include computer-readable instructions. The processor 111 may be configured to execute computer-readable instructions, such as those stored in the memory 112, and through execution of the computer-readable instructions, the processor 111 may be configured to perform one or more, or any combination, of the operations and/or methods described herein.

The processor 111 may be configured to execute programs or applications to configure the processor 1111 to control the electronic device 110 to perform one or more or all operations and/or methods involving the conversational comprehension, and may include any one or a combination of two or more of, for example, a central processing unit (CPU), a graphic processing unit (GPU), a neural processing unit (NPU) and tensor processing units (TPUs), but is not limited to the above-described examples.

In an example, the electronic device 110 may be a device for evaluating the conversational agent 120 and may include various computing devices, such as a mobile phone, a smartphone, a tablet personal computer (PC), an e-book device, a laptop, a PC, a desktop, a workstation, or a server, various wearable devices, such as a smart watch, smart eyeglasses, a head-mounted display (HMD), or smart clothing, various home appliances such as a smart speaker, a smart television (TV), or a smart refrigerator, and other devices, such as a smart vehicle, a smart kiosk, an Internet of things (IoT) device, a walking assist device (WAD), a drone, or a robot, but examples are not limited thereto. For ease of description, the electronic device 110 may be referred to as a conversational simulation device or a conversational agent evaluation system.

The electronic device 110 may transmit and receive data by being connected to the conversational agent 120 by wire or wirelessly to communicate with each other. The electronic device 110 may transmit conversation data and a predetermined query related to the conversation data to the conversational agent 120. The electronic device 110 may receive a response to the transmitted query from the conversational agent 120. In FIG. 1, the only one conversational agent 120 is illustrated for description, but examples are not limited thereto, and the number of conversational agents communicating with the electronic device 110 may be plural, and the electronic device 110 may determine conversational comprehension of the plural conversational agents.

The electronic device 110 may include the conversational agent 120. In this case, the conversational agent 120 may generate a response to the query by using conversation data stored in the memory 112. In addition, the electronic device 110 may evaluate the conversational comprehension of the specific conversational agent 120 included in the electronic device 110.

In an example, the conversational agent 120 may represent a device that generates a natural language response or a device including a processor that generates a natural language response. The conversational agent 120 may include an artificial intelligence (AI) model. In response to receiving a query, the conversational agent 120 may generate a response to the query based on the conversation data. The conversational agent 120 may transmit the generated response to the electronic device 110. The conversational agent 120 may store the conversation data and may update the conversation data based on conversations that the conversational agent 120 has conducted with a plurality of speakers according to a flow of the conversations. The conversational agent 120 may understand a conversation context between the plurality of speakers included in the conversation data and generate a response to a random query received at a random timepoint.

In an example, the electronic device 110 may determine the conversational comprehension of the conversational agent 120 based on the received response. The conversational comprehension may indicate an ability of the conversational agent 120 to understand long-term conversations included in the conversation data and to respond appropriately based on the conversations. The electronic device 110 may compare the received response with a correct answer corresponding to the query and determine the conversational comprehension of the conversational agent 120 based on a comparison result. The electronic device 110 may determine the conversational comprehension of the conversational agent 120 based on comparison results determined by repeatedly performing the transmitting of the query for a predetermined period of time, the receiving of the response, and the comparing of the response with the correct answer. By determining the conversational comprehension of the conversational agent 120, the electronic device 110 may evaluate whether the conversational agent 120 is capable of generating an appropriate response within an appropriate time according to a conversation. Through this, the electronic device 110 may help increase a performance, reliability, and efficiency of the conversational agent 120 and help select a conversational agent suitable for a service to be provided.

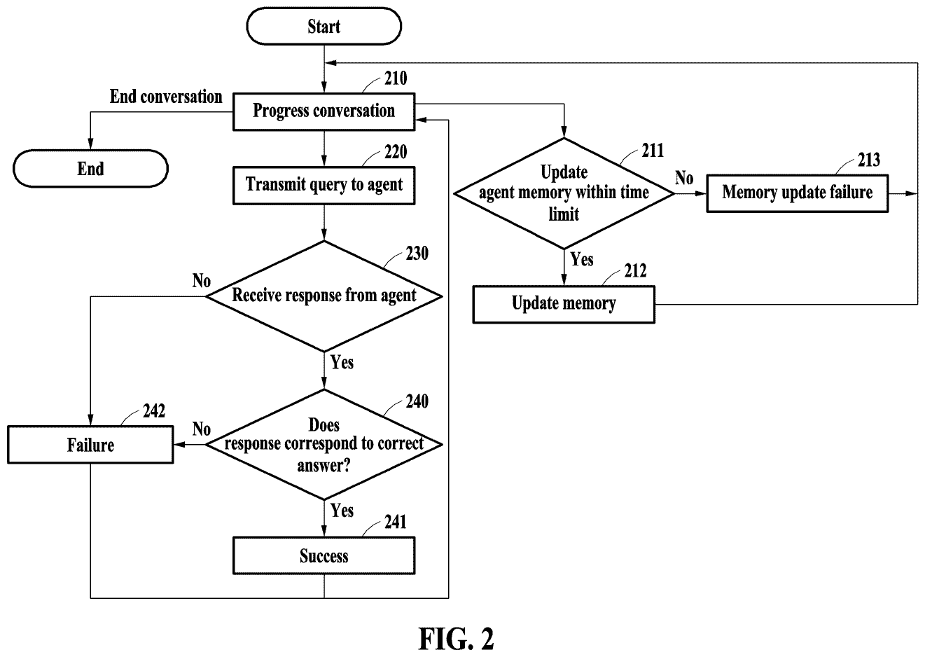

An operation of the electronic device 110 to evaluate the conversational comprehension of the conversational agent 120 is described in greater detail below with reference to FIGS. 2 to 4.

FIG. 2 illustrates an example method with conversational comprehension according to one or more embodiments.

Referring to FIG. 2, in the non-limiting examples, operations may be performed sequentially, but not necessarily. For example, the order of the operations may change, and at least two of the operations may be performed in parallel. The operations illustrated in FIG. 2 may be performed by a conversational agent or at least one component (e.g., a processor) of an electronic device.

In an example, in operation 210, a conversation between a plurality of speakers may proceed. A conversation may proceed by each of the plurality of speakers transmitting conversation data to an electronic device (e.g., the electronic device 110) via a user terminal (e.g., a computer or a mobile phone) and the electronic device transmitting the received conversation data to other speakers. The electronic device may provide one or more sessions in which a conversation may take place, and a conversation may take place based on different conversation data in each of the sessions. For example, each of the sessions may include conversation data of conversations conducted at different times. In addition, each of the sessions may correspond to a set of predetermined queries and a set of predetermined answers (i.e., answers considered the correct responses for a respective query of the set of predetermined queries) corresponding to the query set. The electronic device may transmit the conversation data to the conversational agent. For example, the electronic device may transmit conversation data corresponding to a simulated session to the conversational agent. The electronic device may transmit the conversation data to the conversational agent sequentially according to a flow of a conversation.

In an example, in operation 211, the conversational agent may update the conversation data within a predetermined time limit (e.g., 1 second or 3 seconds). The conversational agent may store the conversation data in a memory and may update the conversation data in response to receiving the conversation data from the electronic device. The conversation data may be updated based on conversations that the conversational agent has conducted with the plurality of speakers.

In an example, in operation 212, when the conversational agent successfully updates the conversation data within a predetermined time limit, the conversational agent may use the updated conversation data to generate a response to the query and conduct a follow-up conversation on the received conversation data. The electronic device may generate the response to the query based on conversation data received up to a timepoint of receiving the query. The conversational agent may transmit to the electronic device whether the update of the conversation data was successful. By successfully updating the conversation data, the conversational agent may generate a more accurate and appropriate response to the query.

In an example, in operation 213, when the conversational agent fails to update the conversation data within a predetermined time limit, the conversational agent may utilize the stored conversation data to generate a response to the query and conduct a follow-up conversation based on the received conversation data. When an update to the conversation data is not performed within a predefined time limit, the update to the conversation data may be skipped. Subsequently, a next utterance may proceed.

In an example, in operation 220, the electronic device may transmit a predetermined query related to the conversation data to the conversational agent. The electronic device may transmit one of a set of predetermined queries related to the conversation data to the conversational agent at a random timepoint while a conversation is in progress. For example, the electronic device may transmit, to the conversational agent, a randomly selected query from a set of predetermined queries corresponding to a simulated session. In addition, the predetermined queries may be one of an objective query, a subjective query, and a descriptive query. The electronic device may, for each conversation session, transmit a query randomly determined by a randomly determined querier to the conversational agent at a random time.

In an example, in operation 230, the electronic device may receive a response to the query from the conversational agent within a predetermined time limit (e.g., 1 second, 3 seconds, or 5 seconds). When the electronic device does not receive a response within a predetermined time limit, the electronic device may skip receiving the corresponding response from the conversational agent.

In an example, in operation 240, the electronic device may determine whether the received response corresponds to a correct answer corresponding to the query. The electronic device may compare the response with the correct answer corresponding to the query to determine a comparison result. For example, the objective query may correspond to a correct answer which may be one of multiple choice options, and the subjective query and the descriptive query may correspond to a single word, phrase, or sentence. In addition, the electronic device may compare the response with correct answers determined differently for each of the plurality of speakers. For example, the correct answer corresponding to the query may vary depending on a speaker that makes a query.

The electronic device may determine a similarity (i.e., a similarity value) between a response and a correct answer. The electronic device may determine the comparison result to be a first value (e.g., “1,” “success”) when a value of the similarity is greater than or equal to a preset value, and may determine the comparison result to be a second value (e.g., “0,” “failure”) when the similarity is less than the preset value. In a case of a subjective query or a descriptive query, the electronic device may use a large language model (LLM) to determine the similarity. The electronic device may determine the similarity between the response and the correct answer as a result of the comparison.

In an example, in operation 241, when the electronic device determines that the received response corresponds to the correct answer, the electronic device may determine that the conversational agent has successfully responded. The electronic device may determine the comparison result for that response to be the first value.

In an example, in operation 242, when the electronic device determines that the received response does not correspond to the correct answer, the electronic device may determine that the conversational agent may determine has failed to respond. In addition, when a response is not received within a predetermined time limit, the electronic device may determine that the conversational agent has failed to respond. The electronic device may determine the comparison result for that response to be the second value.

After either one of operation 241 or operation 242, the electronic device may continue to transmit conversation data and queries to the conversational agent. For example, the electronic device may determine comparison results by repeatedly performing operation 220 of transmitting a query, operation 230 of receiving a response, and operation 240 of comparing a response with a correct answer. The electronic device may determine the conversational comprehension of the conversational agent based on a ratio of a number of the first values and a number of the second values among the comparison results. Alternatively, the electronic device may determine the conversational comprehension of the conversational agent based on similarities determined as a result of the comparison. For example, an electronic device may determine the conversational comprehension of the conversational agent by using an average or a distribution of the similarities.

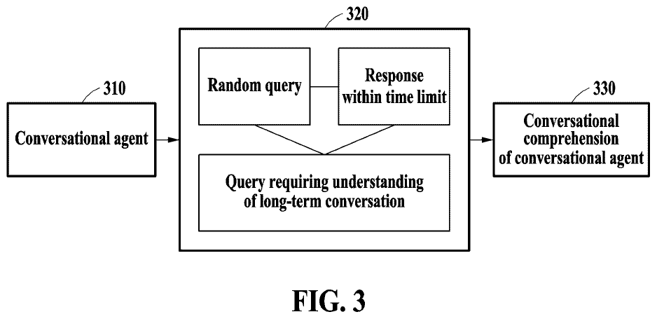

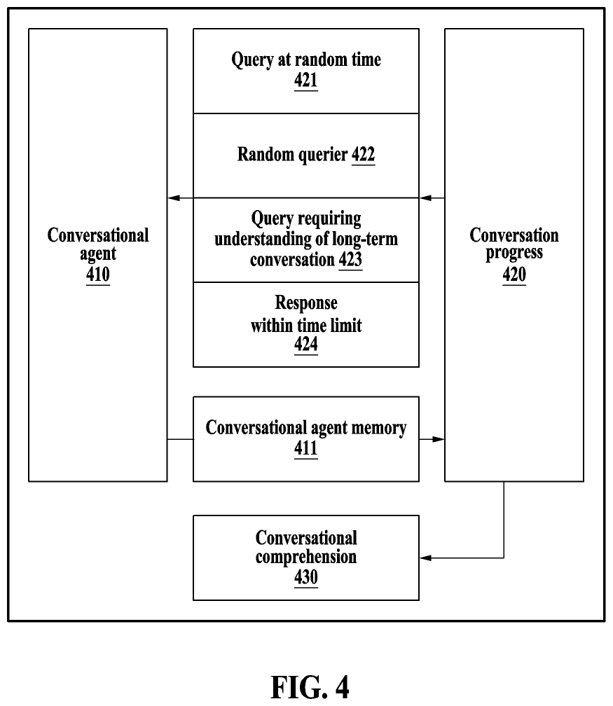

FIGS. 3 and 4 illustrate example processes according to one or more embodiments.

Referring to FIG. 3, in a non-limiting example, an electronic device 320 (e.g., the electronic device 110) may determine conversational comprehension 330 of a conversational agent 310 through random queries, queries requiring understanding of long-term conversations, and whether a response is made within a time limit. The electronic device 320 may determine the conversational comprehension 330 by evaluating a real-time interaction, understanding of a multi-party conversation, and long-term context dependency of the conversational agent 310.

In an example, the conversational agent 310 may perform a specific role in a conversation. For example, the electronic device 320 may perform a simulation by transmitting conversation data regarding various situations that may be encountered by the role of the conversational agent 310 during a conversation. The electronic device 320 may send a random query to the conversational agent 310 during the simulation, and the conversational agent 310 may need to respond accurately to the query. Through the above process, the electronic device 320 may evaluate an ability of the conversational agent 310 to respond appropriately to the conversation in real time.

A time limit for receiving a response may be set to evaluate whether the conversational agent 310 may respond appropriately in real time. The time limit may be determined by a developer or a user of the conversational agent 310 or by a user of the electronic device 320 that intends to evaluate the conversational agent 310. The electronic device 320 may evaluate a real-time response ability of the conversational agent 310 by simulating a situation in which an immediate response is required during a conversation by a time limit. Through the above process, the electronic device 320 may determine the conversational comprehension 330 by quantitatively evaluating an accuracy and a response speed of the conversational agent 310. The conversational comprehension 330 of the conversational agent 310 may be determined differently depending on whether a time limit is set or not. For example, when a time limit is set, the conversational agent 310 having a smaller model size may have a faster inference speed and may thus be determined to have a higher conversational comprehension. When a time limit is not set, the conversational agent 310 having a larger model size may have a higher inference performance and may thus be determined to have a higher conversational comprehension. The model size of the conversational agent 310 may be selected by considering a balance between an inference time and an inference ability for performing a real-time conversation.

The electronic device 320 may evaluate the conversational comprehension 330 of the conversational agent 310 by using long-term conversation data between multiple entities. For example, the conversation data may include a preset number (e.g., hundreds of thousands) of or more tokens. A token may represent a basic unit used by the conversational agent 310 to process and understand the conversation data. For example, the token may be determined to be four letters or one syllable, but examples are not limited thereto. The electronic device 320 may transmit, to the conversation agent 310, a query requiring understanding of a long-term conversation. The conversational agent 310 may determine a conversation context based on the tokens to generate a response. Through the above process, the electronic device 320 may evaluate whether the conversational agent 310 may store conversation data for a plurality of conversation sessions and generate an appropriate response based on the conversation data. The electronic device 320 may simultaneously evaluate an understanding of a long-term conversation and a real-time response of the conversational agent 310.

In addition, the electronic device 320 may randomly determine one query of a set of predetermined queries and transmit the determined query to the conversational agent 310 so that the electronic device 320 may evaluate whether the conversational agent 310 may consistently maintain high performance for randomly given queries.

Referring to FIG. 4, in a non-limiting example, a flow is illustrated in which a conversational agent 410 generates a response to a query according to a conversation progress in operation 420.

In an example, in operation 420, an electronic device (e.g., the electronic device 110) may perform operations 421 to 424 on the conversational agent 410 while a conversation is in progress.

In an example, in operation 421, the electronic device may transmit a query to the conversational agent 410 at a randomly determined timepoint while the conversation is in progress.

In an example, in operation 422, the electronic device may transmit, to the conversational agent 410, a query corresponding to a randomly determined querier among a plurality of speakers. The conversational agent 410 may transmit, to the electronic device, different responses depending on queriers. The electronic device may compare a correct answer with the response corresponding to the query and the querier.

In an example, in operation 423, the electronic device may transmit a query requiring understanding of a long-term conversation to the conversational agent 410.

In an example, in operation 424, the electronic device may determine whether the response has been received from the conversational agent 410 within a time limit.

In an example, in operation 411, the conversation agent 410 may update conversation data stored in a memory. The conversational agent 410 may generate a response and proceed with a follow-up conversation, based on updated conversation data.

In an example, in operation 430, the electronic device may determine conversational comprehension of the conversational agent 410 based on responses received according to the conversation progress.

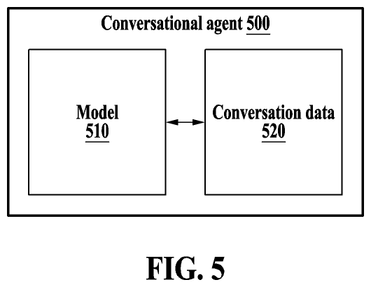

FIG. 5 illustrates an example conversational agent according to one or more embodiments.

Referring to FIG. 5, in a non-limiting example, a conversational agent 500 may include a model 510 and store conversation data 520 in a memory. The conversation data 520 may be stored in a memory within the conversational agent 500 or in an external memory.

In an example, the conversational agent 500 may generate a response to a query by using a model 510 that is pre-trained. A method by which the conversational agent 500 generates a response to the query based on conversation data 520 may vary depending on the example. For example, the model 510 may be a model trained for not only the conversation data 520 but also other natural language data. For example, the conversational agent 500 may generate the response to the query based on an LLM. In an example, the LLM may be implemented as an artificial neural network including a plurality of parameters and a plurality of layers and may be trained by using various training methods (e.g., supervised learning and unsupervised learning). The LLM may have parameters and weights determined according to learning or may be quantized or pruned for optimization. The LLM may process, understand, and generate natural language by using pre-learned data, data on a connected network, and the conversation data 520 that is stored. For example, the conversational agent 500 may generate the response to the query based on the conversation data 520 based on a pre-trained LLM. In addition, depending on the example, the conversational agent 500 may generate the response to the query by using a natural language processing (NLP) model, a natural language understanding (NLU) model, or a natural language generation (NLG) model.

The conversational agent 500 may store and update the conversation data 520 for reference by the model 510. The storing and the updating of the conversation data 520 may affect a determination of conversational comprehension of the conversational agent 500. The conversational agent 500 may store and update the conversation data 520 in the memory. For example, the conversational agent 500 may update the conversation data 520 based on retrieval-augmented generation (RAG) or update the conversation data 520 by storing the conversation data 520 in a conversation context, but examples are not limited thereto.

In the case of a RAG-based memory storage method, the conversational agent 500 may efficiently manage and retrieve the conversation data 520 by utilizing an external memory. In the case of a RAG-based memory storage method, for example, the conversational agent 500 may store the conversation data 520 in a session-level storage method, an utterance-level storage method, or a conversation session summary storage method. The session-level storage method may store an entire conversation session and may thus be suitable for retrieving received queries when queries for a specific session is received. The utterance-level storage method may store each utterance separately and may thus allow more detailed retrieval. The conversation session summary storage method compresses key information of a conversation before storing and may thus improve a retrieval speed of the conversation data 520 and reduce a size of the conversation data 520.

For example, memory retrieval of the conversational agent 500 may be performed by utilizing a retrieval algorithm (e.g., BM25) and/or a vector database. When using BM25 as a retrieval algorithm, the conversational agent 500 may retrieve highly relevant information based on keyword matching between a text and a query. BM25 may be useful for memory retrieval when a query includes a specific keyword. When using a vector database, the conversational agent 500 may store the conversation data 520 in an embedding form and perform memory retrieval based on a semantic similarity. The vector database may also be useful for effectively retrieving relevant information when queries are not specific.

In a case of a method of storing a conversation context, the conversational agent 500 may internally update the conversation context and maintain the conversation context. The conversational agent 500 may store the conversation context without searching in an external memory and may generate a response based on the stored conversation context. In this case, the conversation data 520 may include the conversation context. Storing the conversation context may be advantageous in a situation with a time limit and may allow continuity of conversation and maintenance of a natural context.

In a simulation, depending on the situation, the conversational agent 500 may select an appropriate memory update method to update the conversation data 520, and the electronic device may evaluate a real-time response ability, an ability to understand a long-term conversation, and an inference ability of the conversational agent 500 to determine the conversation comprehension of the conversational agent 500. Through the above process, the electronic device may comprehensively measure how effectively the conversational agent 500 may operate in various environments.

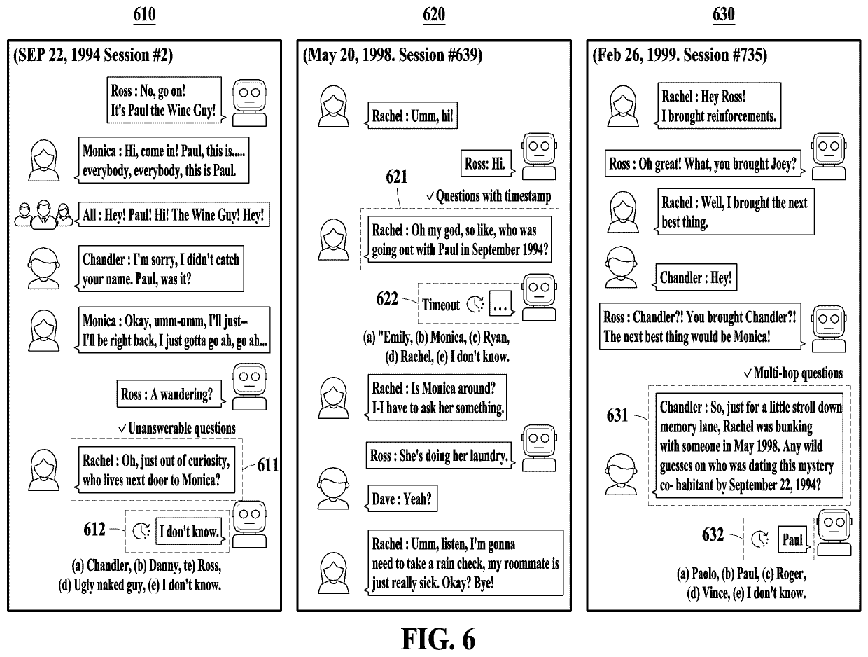

FIG. 6 illustrates an example process of determining conversational comprehension according to one or more embodiments.

Referring to FIG. 6, examples of simulations 610, 620, and 630 performed by an electronic device (e.g., electronic device 110) are shown, in which queries 611, 621, and 631 received by a conversational agent and responses 612, 622, and 632 generated by the conversational agent are illustrated. The simulations 610, 620, and 630 shown in FIG. 6 are only examples for description, and examples are not limited thereto. Various queries may be determined depending on situations, and various responses may be generated according to the queries.

In the simulation 610, the electronic device may transmit, to the conversational agent, the query 611 in an objective form that does not have a corresponding correct answer. In response to receiving the query 611, the conversational agent may generate the response 612. The electronic device may compare the response 612 of the conversational agent with a correct answer. For example, when there is no correct answer corresponding to the query 611, the electronic device may determine whether the response 612 of the conversational agent indicates that there is no correct answer (e.g., “I don't know” or “Unanswerable”).

In the simulation 620, the electronic device may transmit, to the conversational agent, the query 621 that may need to reference time information (e.g., a timestamp). In response to receiving the query 621, the conversational agent may generate the response 622 by referencing the time information. When the response 622 from the conversational agent is not received within a time limit, the electronic device may determine that the conversational agent has failed to respond to the query 621. In this case, the electronic device may determine that the conversational agent has failed without having to compare the response 622 with the correct answer. That is, in examples where the conversational agent fails to meet a time limit, the reply may not be considered.

In the simulation 630, the electronic device may transmit, to the conversational agent, the query 631 in a subjective form that requires understanding of a conversation in another session (e.g., a previous session). The set of queries corresponding to a simulated session may include queries that require understanding of conversations from previous sessions. For example, the set of queries may include queries that may be responded to by referencing information of conversation data from previous sessions. For ease of description, a query that requires understanding of conversations in other sessions may be referred to as a multi-hop query. In response to receiving the query 631, the conversational agent may generate the response 632 by referencing other sessions. The electronic device may compare the response 632 of the conversational agent with a correct answer.

In examples, electronic device may determine conversational comprehension of the conversational agent based on the responses 612, 622, and 632 of the conversational agent.

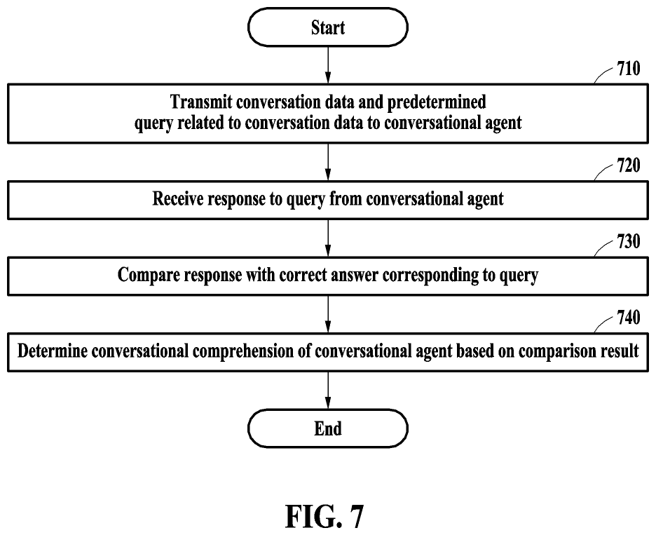

FIG. 7 illustrates an example method according to one or more embodiments.

In the following examples, operations may be performed sequentially, but not necessarily. For example, the order of the operations may change, and at least two of the operations may be performed in parallel. Operations 710 to 740 may be performed by at least one component (e.g., a processor) of an electronic device (e.g., electronic device 110).

In an example, in operation 710, the electronic device may transmit conversation data between a plurality of speakers and a predetermined query related to the conversation data to a conversational agent. The electronic device may transmit the conversation data to the conversational agent sequentially according to a flow of a conversation. The electronic device may transmit one of a set of predetermined queries at a random timepoint while a conversation is in progress.

A conversational agent may, in response to receiving the query, generate a response to the query based on the conversation data. The conversational agent may generate the response to the query based on conversation data received up to a timepoint of receiving the query. Conversation data stored in the conversational agent that is utilized when the conversational agent conducts a conversation with the plurality of speakers may be updated based on a conversation that the conversational agent has conducted with the plurality of speakers. The conversational agent may utilize updated conversation data to conduct a follow-up conversation. When an update to conversation data is not performed within a predetermined time limit, the update to the conversation data may be skipped. That is, the updating of the conversation data may be skipped when a current update is not performed within a predetermined period of time. The conversation data may include a preset number of tokens, and the conversational agent may determine a conversation context based on the tokens to generate the response.

In an example, in operation 720, the electronic device may receive the response to the query from the conversational agent.

In an example, in operation 730, the electronic device may compare the response with a correct answer corresponding to the query. The electronic device may determine a similarity between the response and the correct answer, and when the similarity is greater than or equal to a preset value, the electronic device may determine the comparison result to be a first value, and when the similarity is less than the preset value, may determine the comparison result to be a second value. The electronic device may compare the response with correct answers determined differently for each of the plurality of speakers.

In an example, in operation 740, the electronic device may determine a conversational comprehension (i.e., an ability to comprehend a conversation) of the conversational agent based on the comparison result. The electronic device may determine the conversational comprehension based on comparison results that are determined by repeatedly performing the transmitting of the query, the receiving of the response, and the comparing of the response with the correct answer. That is, the determining of the conversational comprehension may be from an iterative process of transmitting queries, receiving responses, and comparing those responses with predetermined (i.e., correct) answers. The electronic device may determine the conversational comprehension based on a ratio of the first value to the second value among the comparison results. For example, in one type of failure to comprehend the conversation by the conversational agent, the electronic device may determine the comparison result as the second value when the response is not received within a predetermined time limit. In other example, the comparison result may be based on the ability of the conversational agent to handle a multi-hop query in a conversation. In another example, the ability of the conversational agent may be based on its ability to give a correct answer, or in other cases, to indicate that there is no correct answer to be given.

As the description above with reference to FIGS. 1 to 6 may apply to each of the operations shown in FIG. 7, a more detailed description thereof is omitted.

The electronic devices, processors, memories, neural networks, conversational agents, electronic device 110, processor 111, memory 112, conversational agent 120, electronic device 320, conversational agent 310, conversational agent 410, conversational agent memory 411, and conversational agent 500 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
transmitting, to a conversational agent, conversation data between a plurality of speakers and a predetermined query related to the conversation data;
receiving a response to the query from the conversational agent;
comparing the response with a predetermined answer corresponding to the query; and
determining a conversational comprehension of the conversational agent based on a comparison result resulting from the comparing,
wherein the conversational agent is configured to generate the response to the query based on the conversation data upon receiving the query.

2. The method of claim 1, wherein the comparing of the response with the predetermined answer comprises:
determining a similarity value between the response and the predetermined answer;
in response to the similarity value being greater than or equal to a preset value, determining the comparison result to be a first value; and
in response to the similarity value being less than the preset value, determining the comparison result to be a second value.

3. The method of claim 2, wherein the determining of the conversational comprehension comprises:
determining the conversational comprehension based on comparison results from repeatedly performing the transmitting of the query, the receiving of the response, and the comparing of the response with the predetermined answer.

4. The method of claim 2, wherein the determining of the conversational comprehension comprises:
determining the conversational comprehension based on a ratio of the first value to the second value.

5. The method of claim 2, wherein the determining of the conversational comprehension comprises:
determining the comparison result to be the second value responsive to the response not being received within a predetermined time limit.

6. The method of claim 1, wherein the transmitting of the conversation data comprises:
transmitting the conversation data to the conversational agent sequentially according to a flow of a conversation, and
wherein the conversational agent is configured to generate the response to the query based on conversation data received up to a timepoint of receiving the query.

7. The method of claim 1, wherein the conversation data stored in the conversational agent is updated based on conversations conducted between the conversational agent and the plurality of speakers, and
wherein the conversational agent is configured to conduct a follow-up conversation by utilizing updated conversation data.

8. The method of claim 7, further comprising:
skipping the updating of the conversation data responsive to a current update to the conversation data not being performed within a predetermined time limit,.

9. The method of claim 1, wherein the conversation data comprises:
a preset number of tokens, and
wherein the conversational agent is configured to:
determine a conversation context based on the tokens to generate the response.

10. The method of claim 1, wherein the transmitting of the query comprises:
transmitting one of a set of predetermined queries at a random timepoint while a conversation is in progress.

11. The method of claim 1, wherein the comparing of the response with the predetermined answer comprises:
comparing the response with predetermined answers determined differently for each of the plurality of speakers.

12. An electronic device, comprising:
one or more processors comprising processing circuitry; and
a memory comprising one or more storage media storing instructions that, when executed individually or collectively by the one or more processors, cause the electronic device to:
transmit, to a conversational agent, conversation data between a plurality of speakers and a predetermined query related to the conversation data;
receive a response to the query from the conversational agent;
compare the response with a predetermined answer corresponding to the query; and
determine a conversational comprehension of the conversational agent based on a comparison result resulting from the comparing,
wherein the conversational agent is configured to generate the response to the query based on the conversation data upon receiving the query.

13. The electronic device of claim 12, wherein the instructions, when executed by the one or more processors, cause the electronic device to:
determine a similarity value between the response and the predetermined answer;
in response to the similarity value being greater than or equal to a preset value, determine the comparison result to be a first value; and
in response to the similarity value being less than the preset value, determine the comparison result to be a second value.

14. The electronic device of claim 13, wherein the instructions, when executed by the one or more processors, cause the electronic device to:
determine the conversational comprehension based on comparison results that are from iteratively performing the transmitting of the query, the receiving of the response, and the comparing of the response with the predetermined answer.

15. The electronic device of claim 14, wherein the instructions, when executed by the one or more processors, cause the electronic device to:
determine the conversational comprehension based on a ratio of the first value to the second value.

16. The electronic device of claim 13, wherein the instructions, when executed by the one or more processors, cause the electronic device to:
determine the comparison result to be the second value responsive to the response not being received within a predetermined time limit.

17. The electronic device of claim 12, wherein the instructions, when executed by the one or more processors, cause the electronic device to:
transmit the conversation data to the conversational agent sequentially according to a flow of a conversation, and
wherein the conversational agent is configured to generate the response to the query based on conversation data received up to a timepoint of receiving the query.

18. The electronic device of claim 12, wherein the conversation data stored in the conversational agent is updated based on conversations conducted between the conversational agent and the plurality of speakers, and
wherein the conversational agent is configured to conduct a follow-up conversation by utilizing updated conversation data.

19. The electronic device of claim 18, wherein the instructions, when executed by the one or more processors, cause the electronic device to:
skip the updating of the conversation data responsive to a current update to the conversation data not being performed within a predetermined time limit.

20. A non-transitory, computer-readable storage medium storing instructions that, when executed by a processor, cause the processor to perform the method of claim 1.
